(19) United States
(12) Patent Application Publication
(10) Pub. No.: US 2024/0384493 A1
(43) Pub. Date: Nov. 21, 2024

(54) FOUNDATION FOR A TOWER FOR A WIND TURBINE

(71) Applicant: SMART & GREEN MUKRAN CONCRETE GMBH, Sassnitz (DE)

(72) Inventors: Christoph SCHRIEFER, Redefin (DE); Gregor PRASS, Hamburg (DE)

(21) Appl. No.: 18/686,424

(22) PCT Filed: Aug. 3, 2022
(86) PCT No.: PCT/EP2022/071886

§ 371 Date: Feb. 25, 2024

(30) Foreign Application Priority Data
Aug. 26, 2021 (DE) 10 2021 122 183.8

(51) Int. Cl. E02D 27/42

(52) U.S. Cl. CPC E02D 27/425; E02D 2300/002

(57) ABSTRACT

The invention relates to a foundation for a tower for a wind turbine, wherein the foundation (10) essentially comprises prefabricated elements, preferably made of reinforced concrete, with a first, vertically extending pedestal-like section (11), on which a tower of the wind turbine can be arranged, and a second, essentially horizontally extending section (12) as foundation body, which is in contact with the ground, wherein the first section (11) is arranged above the second section (12), and wherein the first section (11) is formed from at least one annular pedestal section (16, 17) which has an inner space (15), and wherein the second section is formed from at least two horizontal elements (22), wherein the at least two horizontal elements (22) each have at least one support section (25, 21) on which the annular pedestal section is arranged (16, 17). According to the invention, it is provided that a clamping device (70) is provided with at least one clamping element (71, 72), wherein the at least one clamping element (71, 72) is connected to at least two horizontal elements (22).

The invention relates to a foundation for a tower for a wind turbine, the foundation having essentially prefabricated elements, preferably made of reinforced concrete, with a first, vertically extending pedestal-like section, on which a tower of the wind turbine can be arranged, and a second, essentially horizontally extending section as foundation body, which is in contact with the ground, wherein the first section is arranged above the second section, and wherein the first section is formed from at least one annular pedestal section which has an interior, and wherein the second section is formed from at least two horizontal elements, wherein the at least two horizontal elements each have at least one support section on which the annular pedestal section is arranged.

Foundations for wind turbines are generally constructed as in-situ concrete foundations. For this purpose, a pit is excavated at the installation site and provided with a clean layer. The formwork and reinforcement are then installed and the whole thing is filled with concrete on site. A flat body is erected, possibly with a pedestal, see for example U.S. Pat. No. 20,160,369520 A1 or WO 2008/036934 A2. In addition to the transportation effort involved in delivering the concrete, formwork and reinforcement, this is very labor-intensive on site. Quality assurance is also time-consuming and, depending on the weather, problematic. Furthermore, dismantling at the end of the wind turbine's service life is expensive and very time-consuming. This applies in particular to concrete towers for wind turbines, which ideally have a diameter to height ratio of approx. 1:10, meaning that diameters of 8 to 15 m are not uncommon. Foundations for such towers are currently made of in-situ concrete. Furthermore, areas must be provided in which the prestressing elements of the tower can be attached to the foundation and prestressed. Prestressing is carried out using devices designed for this purpose, which must be placed in the prestressing areas. Complex cantilever structures are usually provided inside the foundation as abutments for prestressing or for attaching the prestressing elements (strands/cables), under which the devices are then placed. These structures are complex and in need of improvement.

In principle, there is also a need to construct wind turbine foundations from prefabricated elements, which could reduce or eliminate the aforementioned problems. In principle, the advantage of prefabrication is that the components can be produced in a standardized manner under defined conditions. This also reduces the amount of work required on site. Various approaches to this have been described in the state of the art.

For example, WO 2008/036934 A2 shows a combination of prefabricated elements and classic formwork/reinforcement construction. This reduces the aforementioned disadvantages only insignificantly.

Further approaches for the manufacture of foundations for wind turbines from prefabricated components are shown in the state of the art as follows:

EP 1 058 787 B1 discloses a foundation for a wind turbine for erecting offshore wind turbines, which are transported fully pre-assembled—i.e. including the foundation—and placed on the seabed in one piece at the installation site. The foundation consists of individual prefabricated segments. These can be made of concrete. A flat section and a pedestal section are disclosed. The pedestal section consists of circular rings. The flat section consists of individual trapezoidal base elements, on which the pedestal section is mounted vertically at the inner end, which has vertical passages. The flat base sections are connected to each other using tongue and groove joints. The pedestal section and the flat base section are connected with a diagonal brace for reinforcement. The circular segments of the pedestal section also have vertical passages. Connecting cables/anchor rods are inserted into the passages. If the foundation parts are made of concrete, a flat steel abutment ring is provided below the base elements in the area of the vertical passages. The foundation is mounted using the connecting cables/anchor rods and the wind turbine is attached to the foundation. In addition, horizontal passages are provided in the base elements and diagonal braces, in which connecting cables/anchor rods are also arranged, with which the elements of the foundation are pretensioned horizontally. The foundation is only completed in a load-bearing manner through the horizontal prestressing. EP 1 058 787 B1 thus discloses a foundation comprising individual prefabricated concrete parts, with a surface section and a base section, whereby at least these two sections are connected to each other vertically and horizontally.

The disadvantage here is that considerable costs and labor are required to connect the elements and create the structurally sound foundation.

EP 1 074 663 A1 discloses a foundation for a wind turbine with a central body as a pedestal with laterally extending star-shaped ribs/projections/beams bolted to it. The ribs and central body are bolted together horizontally on site. The parts are prefabricated from concrete, among other materials, and are delivered to the construction site by truck, arranged by crane and connected together horizontally on-site using flanges and screw connections. Furthermore, anchors are required on the outside of the ribs to ensure sufficient load transfer.

The disadvantage here is that considerable costs and labor are required to connect the elements and create a structurally sound foundation. Additional anchoring is also necessary.

WO 2004/101898 A2 discloses a foundation for a wind turbine consisting of prefabricated individual concrete parts, whereby either a central body is provided to which flat bodies are bolted horizontally, or the foundation consists exclusively of components which have both a flat section and a pedestal-like section, whereby these are then connected to one another horizontally by means of bolting against flanges.

The disadvantage here is that considerable costs and labor are required to connect the elements and create a structurally sound foundation.

EP 2 182 201 A1 discloses two different foundations for a wind turbine. In both, a foundation is constructed from prefabricated concrete parts after delivery on site. Both contain a flat section and a pedestal-like section. In variant 1, a central body is provided. The ribs/surface elements are attached to this. When assembled, the ribs form a polygonal body. The central body has a projection that is surrounded by a corresponding recess on the ribs. The ribs are additionally locked against the central body by means of a lashing ring. Anchor rods for mounting the tower are provided on the surface heads. In the second variant, the ribs have horizontally projecting anchor elements that extend radially into the center of the foundation when installed. Plates are provided below and above the anchors. The in-situ concrete is poured into the cavity formed in this way to connect the anchors to each other and form a central body. Both variants simplify the horizontal connection. However, both the ribs and the central body have dimensions and masses that make transportation complicated.

WO 2017/141095 A1 and WO 2017/141098 A1 also disclose a foundation for a wind turbine. This foundation is formed from prefabricated ribbed bodies which have a pedestal section at their inner end, on which the tower of the wind turbine is arranged. The ribs extend outwards in a radial pattern. In a further embodiment, the sections between the ribs are filled with plate elements that are bolted against the ribs with flanges to produce a plate. In the middle, instead of a central body, a steel sleeve is provided, which is connected to reinforcements provided inside the ribs and reinforcing beams provided in the inner cavity. The ribs have a base plate. A diagonal reinforcing element and the base section are arranged in one piece on the base plate. The base sections are connected to each other horizontally via tongue and groove elements. Furthermore, the pedestal sections have horizontal openings in which clamping elements are provided to connect the pedestal sections horizontally. Anchor rods are also cast into the base sections to connect the tower to the foundation. Also disclosed are external ground anchors. WO 2018/055444 A1 discloses a foundation for a wind turbine with a circular or polygonal base body for supporting a wind turbine tower and several ribs projecting radially outwards from the base body, wherein the base body is divided in the vertical direction into a base ring section and an adapter ring section, wherein the base ring section is divided into several circumferential sections and consists of precast concrete parts, and the adapter ring section also consists of precast concrete parts.

The disadvantage here is that considerable costs and labor are also required to connect the elements and to produce the statically load-bearing foundation.

WO 2019/115622 A1 and WO 2019/201714 A2 disclose first successful foundations for wind turbines made of precast concrete parts for a steel tower and for a concrete tower for a wind turbine. The foundations have two sections. Ribbed elements are provided which have a central section on which a pedestal section is provided. The tower of the wind turbine is then placed on the pedestal section. The pedestal section consists of individual segments that are connected to each other. The rib elements and the pedestal elements are braced together by means of tendons, which are provided in openings in the central section and in the elements of the pedestal section. Further developments of these foundations have resulted in surprising and particularly efficient improvements in the area of the pedestal. WO 2021/064190 A1 discloses a foundation in which prefabricated ribbed elements with an anchor cage and further reinforcement are cast on site using in-situ concrete and a formwork to form a foundation.

The object of the invention is therefore to overcome the aforementioned disadvantages and to make foundations for wind turbines, in particular for wind turbines with steel towers, economically erectable or more erectable from prefabricated elements.

The object according to the invention is solved by providing a clamping device with at least one clamping element, wherein the at least one clamping element is connected to at least two horizontal elements.

It has been shown that this is a simple way to increase the load on the foundation or to install a wind turbine of the same size on a smaller foundation.

A further teaching of the invention provides that a third, vertically extending pedestal-like section is provided below the second section, and that the third section is formed from at least one annular pedestal section which has an interior space.

A further teaching of the invention provides that the at least one clamping element is arranged in an interior space.

According to a further teaching of the invention, the horizontal element has at least one body on which, preferably on or under which, the at least one clamping element is arranged.

A further teaching of the invention provides that the at least one clamping element has at least one projection which engages in an interior space, and/or that the at least one clamping element is composed of at least two element sections.

A further teaching of the invention provides that, in addition to the at least one clamping element, the clamping device has a clamping arrangement which has at least one clamping ring, wherein the at least one clamping ring is connected to at least two horizontal elements. Advantageously, the at least one clamping ring has at least one clamping ring section.

A further teaching of the invention provides that the at least one clamping ring is arranged in an interior space separate from the at least one clamping element, preferably arranged in the interior space around the clamping element.

A further teaching of the invention provides that the at least one clamping element and/or the at least one clamping ring is designed as a ring or as a disk, preferably made of reinforced concrete. This makes it easy to provide optimum tensioning of several horizontal elements.

A further teaching of the invention provides that the at least one clamping element and/or the at least one clamping ring has at least one aperture which extends through the horizontal element and the at least one clamping element or the at least one clamping ring. Advantageously, at least one clamping member is arranged in the at least one aperture, with which the at least one clamping element or the at least one clamping ring can be clamped against the horizontal element. This makes it possible to clamp the clamping element in a simple manner.

A further teaching of the invention provides that the at least one annular pedestal section of the first section is formed from at least two pedestal segments, preferably from reinforced concrete, and/or that the at least one annular pedestal section of the third section is formed from at least two pedestal segments, preferably from reinforced concrete. This facilitates the standardized construction of the foundation and reduces the necessary number of transports to the construction site, especially of in-situ concrete.

According to a further teaching of the invention, the foundation comprises a pedestal consisting of the first section, the third section and the body of the horizontal element.

It is advantageous that the first section is formed from at least two pedestal sections arranged one above the other, which are preferably composed of the pedestal segments, the pedestal sections each having a height (H, I), that the third section is formed from at least two pedestal sections arranged one above the other, which are preferably composed of the pedestal segments, the pedestal sections each having a height, that the body of the horizontal element has a height, and that the height is less than the sum of the pedestal segments, which are preferably composed of the pedestal segments, wherein the pedestal sections each have a height, that the body of the horizontal element has a height, and that the height is less than the sum (2×H+2×I) of the height of the first section and the height of the third section. Surprisingly, this makes it possible to achieve optimum load distribution in the foundation.

A further teaching of the invention provides that the clamping ring sections have a height (K, L) and that the sum of the heights (K, L) of the clamping ring sections, which are arranged above and/or below the body of the horizontal element, is less than the height of the body of the horizontal element. Surprisingly, this makes it possible to achieve optimum load distribution for clamping in the foundation.

The invention is explained in more detail below with reference to embodiments in conjunction with a drawing. It shows:

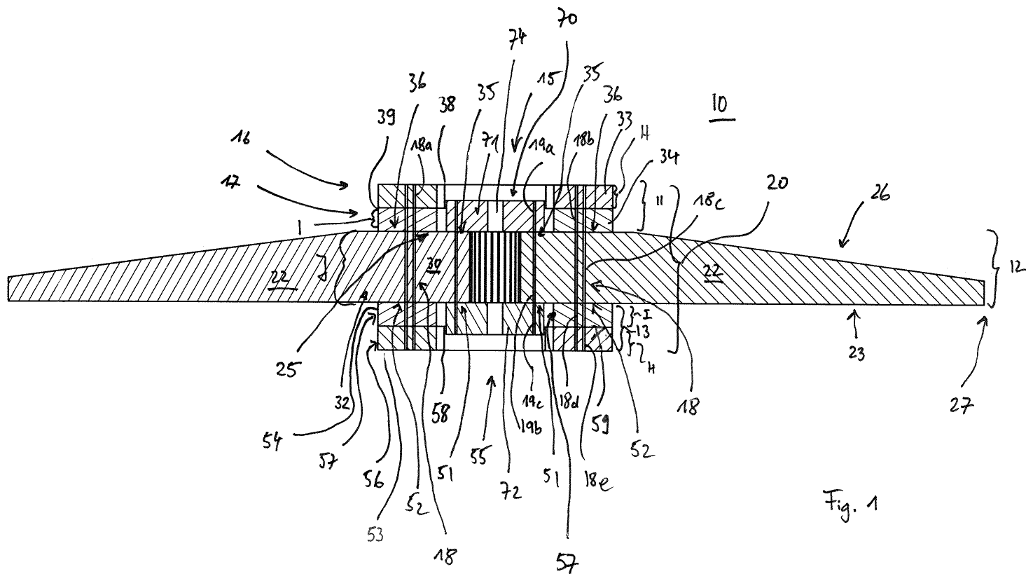

FIG. 1a sectional view of a first embodiment of a foundation according to the invention,

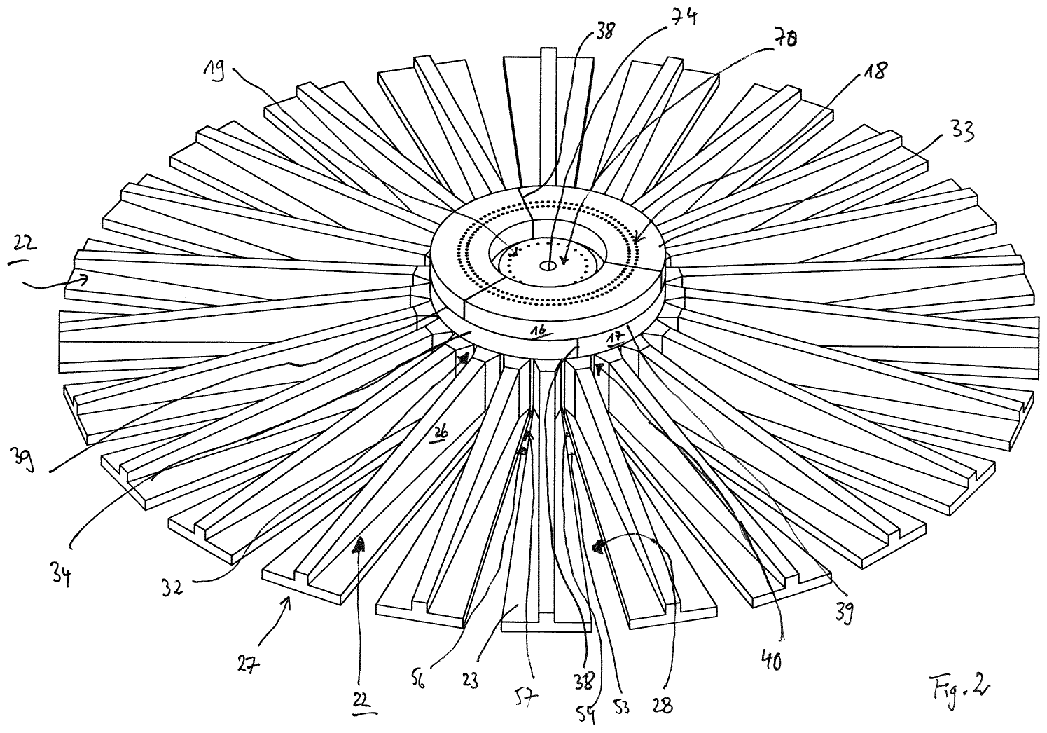

FIG. 2a spatial view of FIG. 1,

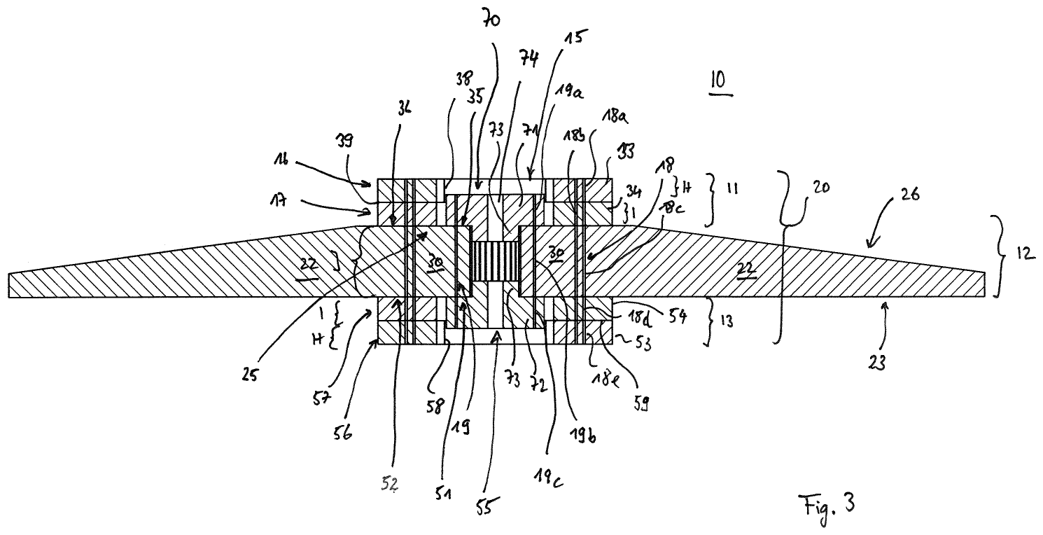

FIG. 3a sectional view of a second embodiment of a foundation according to the invention,

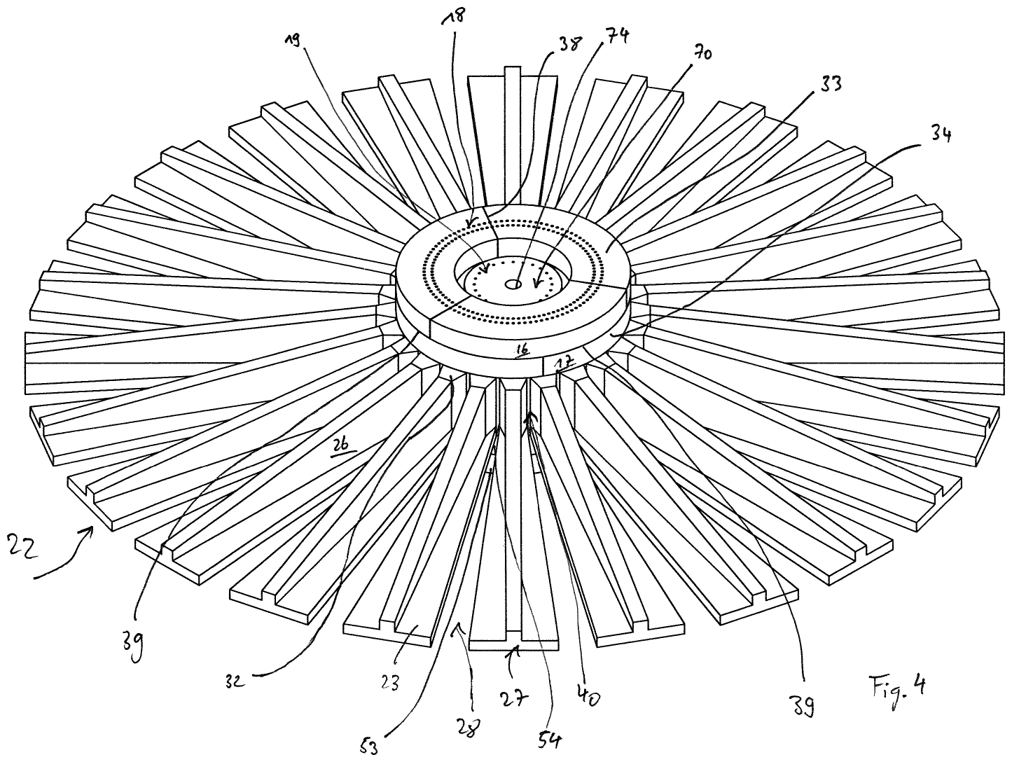

FIG. 4a spatial view of FIG. 3,

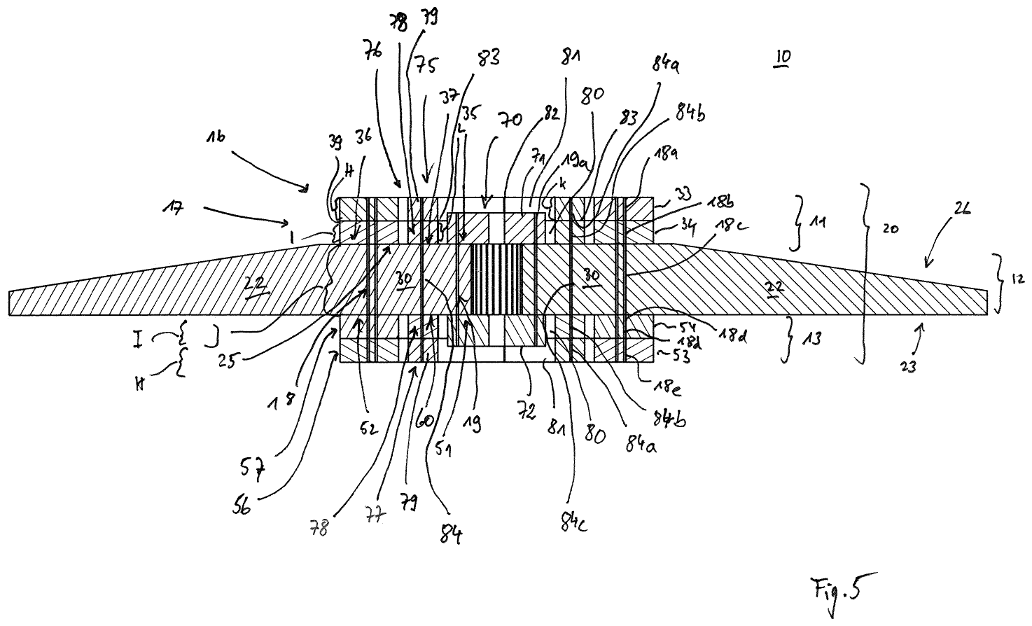

FIG. 5a sectional view of a third embodiment of a foundation according to the invention, and

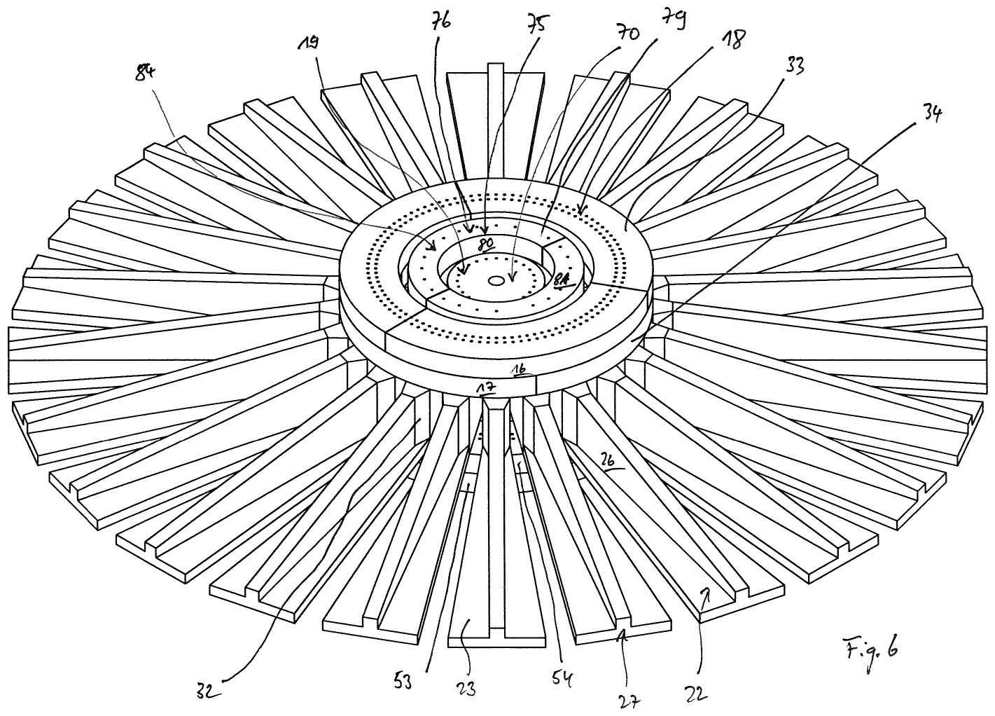

FIG. 6a spatial view of FIG. 5.

FIG. 1 shows a sectional view of a first embodiment of a foundation 10 according to the invention. The foundation 10 is constructed, for example, in a pit (not shown) in the ground (not shown), possibly on a compacted clean layer (not shown). The foundation 10 according to the invention has a first vertically extending pedestal-like section 11 and a second substantially horizontally extending section 12. Furthermore, a third vertically downwardly extending pedestal-like section 13 is provided under the second section 12, which is preferably provided in a recess not shown.

The first section 11 has a pedestal-like design, which is made up of several closed pedestal sections 16, 17. If necessary, further pedestal sections can be provided.

The closed pedestal sections 16, 17 are made up of individual pedestal segments 33, 34. The pedestal sections 16, 17 are preferably designed here as circular rings, so that the pedestal section 11 has an interior 15. An alternative structure, e.g. a polygonal structure, is possible.

The pedestal segments 33, 34 are provided butted next to each other so that there are vertical joints 38 between them. These are preferably designed as a gap, for example with a thickness of several millimeters, e.g. 30 mm. These vertical joints 38 are preferably not filled with mortar or in-situ concrete. Furthermore, preferably no horizontal connecting means are provided. Furthermore, the vertical joints of the individual pedestal sections 16, 17 are preferably provided in such a way that the vertical joints 38 of adjacent pedestal sections 16, 17 are not aligned, i.e. are not arranged one above the other. As shown in FIG. 2, it is advantageous if the vertical joints 38 are always offset clockwise or counterclockwise by essentially the same value. There are horizontal joints 39 between the pedestal sections 16, 17, which are preferably not filled with mortar or in-situ concrete.

The second section 12 is flat. Alternatively, it can also be realized in a star shape. FIG. 2 shows a spatial view of the foundation 10. The second section 12 is made of horizontal elements 22 in the form of ribbed elements. These extend radially outwards as seen from the interior 15.

They have a base plate 23 that is trapezoidal, for example, so that all of the assembled base plates form a polygonal surface that approximates a circular shape, whereby spaces can be provided between the individual base plates. Alternatively, circular segments or a mixed form of circular segment and trapezoidal shape are also possible.

At the inner end 24 of the base plate 23, a body 30 is provided with an upper support section 25 with a lower support section 21 and side walls 29, which is preferably substantially longer than the width of the pedestal segments 33, 34 of the first section 11. Preferably, the support sections 25, 21 have an inner upper section 35 pointing towards the inner spaces 15, 55 and an inner lower section 51 as well as an outer upper section 36 and an outer lower section 52 pointing towards the outer end 27. Preferably, the pedestal sections 16, 17 are arranged on the outer section 35 and the pedestal sections 56, 57 are arranged under the outer section 52.

A stiffening wall 26 is arranged at right angles to the base plate 23, the height of which decreases, for example, towards the outer end 27 of the base plate 23.

The body 30 has a transition area 32 with which the reinforcing wall 26 is connected to the support section 25 in a reinforcing manner.

Between the side surfaces 29 of the support sections 25, a distance is preferably provided as a vertical joint 40 when the horizontal elements 22 are arranged, which is preferably designed as an air gap. This results in vertical joints 40, which are also preferably not filled with mortar or in-situ concrete. Furthermore, preferably no horizontal connecting means are provided.

An upwardly open cavity 28 is formed between two adjacent stiffening walls 26, into which backfill soil (not shown) can be introduced, whereby a ballast load can be applied to the second section 12 of the foundation 10.

The third section 13 has a pedestal-like design, which is made up of several closed pedestal sections 56, 57. If necessary, further pedestal sections can be provided.

The closed pedestal sections 56, 57 are constructed from individual pedestal segments 53, 54. The pedestal sections 56, 57 are preferably designed here as circular rings, so that an interior 55 is provided. An alternative structure, e.g. a polygonal structure, is possible.

The pedestal segments 53, 54 are provided butted next to each other, so that vertical joints 58 exist between them. These are preferably designed as a gap, for example with a thickness of several millimeters, e.g. 30 mm. These vertical joints 38 are preferably not filled with mortar or in-situ concrete. Furthermore, preferably no horizontal connecting means are provided. Furthermore, the vertical joints of the individual pedestal sections 56, 57 are preferably provided in such a way that the vertical joints 58 of adjacent pedestal sections 56, 57 are not aligned, i.e. are not arranged one above the other. As shown in FIG. 2, it is advantageous if the vertical joints 58 are always arranged offset clockwise or counterclockwise by substantially the same value. There are horizontal joints 59 between the pedestal sections 56, 57, which are preferably not filled with mortar or in-situ concrete.

The foundation 10 has openings 18 that extend through the three sections 11, 12, 13. The apertures 18 are made up of the aperture sections 18a to 18e. Tendons are provided in these apertures 18, with which the pedestal segments 33, 34, 53, 54 of sections 11, 13 and the body 30 of section 12 are braced together.

To form the apertures 18, the pedestal segments 33, 34 have vertical aperture sections 18a, 18b to form the apertures 18. Openings 18c are provided in the support section 25 and body 30 for this purpose. The pedestal segments 53, 54 have vertical aperture sections 18d, 18e to form the apertures 18.

To provide the necessary bracing between the pedestal sections 16, 17 of the first section 11, the horizontal elements 22 of the second section 12 and the pedestal sections 56, 57 of the third section 13, an anchor cage (not shown) is preferably formed, which is formed from an upper and a lower abutment (not shown), which are connected to the tendons (not shown), for example in the form of anchor rods or reinforcement rods and counter elements (not shown), for example nuts. The upper abutment may also include a connection adapter (not shown) for a tower (not shown) of a wind turbine (not shown), for example if the tower is a steel tower.

The upper pedestal sections 16, 17 form the pedestal segments 33, 34, the lower pedestal sections 56, 57 form the pedestal segments 53, 54 and the bodies 30 of the horizontal element 22 of the section 12 form the pedestal 20 of the foundation 10.

The pedestal sections 17 and 57 have a height I, the pedestal sections 16 and 56 have a height H and the bodies 30 have a height J.

The height H, I of the upper pedestal sections 16, 17 and the lower pedestal sections 56, 57 is designed in such a way that the pedestal sections 16, 17, 56, 57 are essentially only loaded in tension/compression when installed, i.e. they are loaded in the normal direction. The reinforcement is also designed for this (not shown), which essentially consists of reinforcement in the normal direction. Preferably, the height H and I are the same.

The height J of the bodies 30 is designed in such a way that they are essentially only loaded in shear when installed. The reinforcement is also designed for this (not shown), which essentially consists of reinforcement in the radial direction, particularly preferably in the form of stirrups.

In order to increase the rigidity of the foundation 10, a clamping device 70 is provided, which is connected to the second section 12. The clamping device 70 has at least one clamping element 71, 72. Here, the clamping device 70 preferably has an upper clamping element 71 and a lower clamping element 72, as in FIGS. 1 to 4. Alternatively, only one of the two clamping elements or even more than two clamping elements 71, 72 may be provided, as shown for example and by way of example in FIGS. 5, 6.

Preferably, a clamping element 71, 72 is designed as a continuous ring or as a disk, possibly with an opening 74. For example, a clamping element 71, 72 can also consist of several individual parts. This applies both to an annular design and to a disk-like design, as shown in FIGS. 1 to 4.

The clamping element 70 has at least one aperture 19. The upper clamping element 71 has aperture sections 19a and the lower clamping element 72 has aperture sections 19c. Furthermore, breakthrough sections 19b are provided in the body 30 of the horizontal element 22.

The upper clamping element 71 (if present) is arranged on the inner section 35 of the body 30 of the horizontal element 22 so that the breakthrough sections 19a, 19b are aligned. The lower clamping element 72 (if present) is arranged under the inner section 51 of the body 30 of the horizontal element 22 so that the aperture sections 19b, 19c are aligned.

With the clamping elements 71, 72 mounted, the aperture sections 19a, 19b, 19c form an aperture 19. The upper clamping element 71 is arranged in the interior 15 within the pedestal sections 16, 17 of the first section 11. The lower clamping element 72 is arranged in the interior 55 within the pedestal sections 56, 57 of the third section 13.

In order to achieve a correspondingly effective increase in rigidity, it is necessary to brace the upper clamping element 71 and/or the lower clamping element 72 with the horizontal element 22. To provide the necessary bracing, tendons (not shown), for example in the form of anchor rods or reinforcement rods, are inserted into the apertures 19. These are then tensioned and prestressed with the upper clamping element 71, the lower clamping element 72 and/or the horizontal element 22, for example via counter elements (not shown) such as nuts. It is also possible to design these as a type of anchor basket, as described above.

In the second embodiment of the foundation 10 according to the invention as shown in FIGS. 3, 4, the upper clamping element 71 and/or the lower clamping element 72 each have a projection 73, which can be arranged continuously or intermittently around one side of the clamping element 71, 72. This increases the rigidity of the foundation 10 in a simple manner and improves the clamping 70.

The projection 73 preferably also serves as an assembly aid in connection with the horizontal elements 22. The projection 73 projects into the interior 15, 55. Preferably, the outwardly facing surface of the projection 73 is in contact with the inner surface of the body 30, which faces into the interior 15, 55. Otherwise, the second embodiment is designed in the same way as the first embodiment.

FIGS. 5, 6 show a third embodiment of the foundation 10 according to the invention. In addition to the clamping 70 of the first embodiment according to FIGS. 1, 2 consisting of the upper clamping element 71 and/or the lower clamping element 72, the clamping 70 of the third embodiment has a further clamping element arrangement 75 between the pedestal sections 16, 17 or the pedestal sections 56, 57 and the stiffening elements 71, 72. The further stiffening element arrangement 75 preferably has at least one upper clamping ring 76 and/or one lower clamping ring 77. Preferably, the clamping rings 76, 77 are made in one piece or consist of at least two clamping ring sections 78, 79 arranged one above the other. The clamping rings 76, 77 and/or the clamping ring sections 78, 79 can be designed in one piece or as at least two clamping ring segments 80, 81.

The further clamping element arrangement 75 is arranged on a central section 37, 60 between the outer section 36, 52 and the inner section 35, 51 of the upper and/or lower support section 25, 21 of the body 30.

The clamping ring segments 80, 81 are provided butted next to each other so that there are vertical joints 82 between them. These are preferably designed as a gap, for example with a thickness of several millimeters, e.g. 30 mm. These vertical joints 82 are preferably not filled with mortar or in-situ concrete. Furthermore, preferably no horizontal connecting means are provided. Furthermore, the vertical joints 82 of the individual clamping ring sections 78, 79 are preferably provided in such a way that the vertical joints 82 of adjacent clamping ring sections 78, 79 are not aligned, i.e. are not arranged one above the other. As shown in FIG. 6, it is advantageous if the vertical joints 82 are always arranged offset clockwise or counterclockwise by substantially the same value. There are horizontal joints 83 between the clamping ring sections 78, 79, which are preferably not filled with mortar or in-situ concrete. In addition, the upper clamping element 71 and/or the lower clamping element 72 can each have a projection 73 corresponding to the second embodiment. Otherwise, the third embodiment is designed like the first embodiment.

The clamping element arrangement 75 has at least one aperture 84. The clamping ring sections 78, 79 have aperture sections 84a, 84b. Furthermore, aperture sections 84c are provided in the body 30 of the horizontal element 22.

The clamping ring portions 78, 79 (if present) are arranged on and/or under the central portion 37, 60 of the body 30 of the horizontal member 22 such that the aperture portions 84a, 84b, 84c.

With the clamping ring sections 78, 79 fitted, the aperture sections 84a, 84b, 84c form the aperture 84.

In order to achieve a correspondingly effective increase in rigidity, it is necessary to brace at least one of the clamping ring sections 78, 79 with the horizontal element 22. To provide the necessary bracing, tendons (not shown), for example in the form of anchor rods or reinforcement rods, are inserted into the apertures 84. These are then tensioned and prestressed with the upper clamping ring 76, the lower clamping ring 77 and/or the horizontal element 22, for example via counter elements (not shown) such as nuts. It is also possible to design these as a type of anchor cage, as described above.

The clamping ring sections 78 have a height K, the clamping ring sections 79 have a height L and the bodies 30 have a height J.

The height K and the height L of the clamping ring sections 78, 79 are designed in such a way that the clamping ring sections 78, 79 are essentially only subjected to tension/compression when installed, i.e. they are loaded in the normal direction. The reinforcement is also designed for this (not shown), which essentially consists of reinforcement in the normal direction. Preferably, the heights K and L are the same.

The height J of the bodies 30 is designed in such a way that they are essentially only loaded in shear when installed. The reinforcement is also designed for this (not shown), which essentially consists of reinforcement in the radial direction, particularly preferably in the form of stirrups.

1.-15. (canceled)

16. Foundation for a tower for a wind turbine, comprising prefabricated elements, made of reinforced concrete, with a first, vertically extending pedestal section on which a tower of the wind turbine can be arranged, and a second, horizontally extending section as a foundation body which is in contact with the ground, wherein;
the first section is arranged above the second section;
the first section is formed from at least one annular pedestal section comprising an inner space;
the second section is formed from at least two horizontal elements, wherein the at least two horizontal elements each comprise at least one support section on which the annular pedestal section is arranged; and,
a clamping device with at least one clamping element is provided, the at least one clamping element being connected to at least two horizontal elements.

17. Foundation according to claim 16 wherein a third, vertically extending pedestal-like section is provided under the second section, and the third section is formed from at least one annular pedestal section which has an interior.

18. Foundation according to claim 16, wherein the at least one clamping element is arranged in an interior space.

19. Foundation according to claim 16, wherein the horizontal element has at least one body on which, at least one of on or under the body the at least one clamping element is arranged.

20. Foundation according to claim 16, wherein the at least one clamping element has at least one projection which engages in an inner space.

21. Foundation according to claim 16, wherein the at least one clamping element is composed of at least two element sections.

22. Foundation according to claim 16, wherein the clamping device has, in addition to the at least one clamping element, a clamping arrangement which has at least one clamping ring, the at least one clamping ring being connected to at least two horizontal elements.

23. Foundation according to claim 22, wherein the at least one clamping ring has at least one clamping ring section.

24. Foundation according to claim 22, wherein the at least one clamping ring is arranged in an inner space separately from the at least one clamping element.

25. Foundation according to claim 22, wherein the at least one clamping ring is arranged in the inner space around the clamping element.

26. Foundation according to claim 16, wherein at least one of the at least one clamping element or the at least one clamping ring is at least one of a ring or a disc.

27. Foundation according to claim 16, wherein at least one of the at least one clamping element or the at least one clamping ring has at least one aperture which extends through the horizontal element and one of the at least one clamping element or the at least one clamping ring.

28. Foundation according to claim 27, wherein at least one clamping member is arranged in the at least one aperture, wherein the at least one clamping element or the at least one clamping ring can be clamped against the horizontal element.

29. Foundation according to claim 16, wherein the at least one annular pedestal section of the first section is formed from at least two pedestal segments

30. Foundation according to claim 17, wherein the at least one annular pedestal section of the third section is formed from at least two pedestal segments.

31. Foundation according to claim 17, wherein the pedestal is composed of the first section, the third section and the body of the horizontal element.

32. Foundation according to claim 28, wherein the first section is formed from at least two pedestal sections which are arranged one above the other and are composed of the pedestal segments, the first pedestal section having a first height and the second pedestal section having a second height, wherein the third section is formed from at least two pedestal sections which are arranged one above the other and are composed of the pedestal segments, the pedestal sections having a third height and a fourth height, and wherein the body of the horizontal element has a fifth height, and the fifth height being less than the sum of the first and second height of the first section and the sum of the third and fourth height the height of the third section.

33. Foundation according to claim 23, wherein the clamping ring sections have a height and wherein the sum of the heights of the clamping ring sections arranged above and below the body of the horizontal element is smaller than the height of the body of the horizontal element.
